(19) United States
(12) Patent Application Publication
(10) Pub. No.: US 2023/0332001 A1
(43) Pub. Date: Oct. 19, 2023

(54) AQUEOUS COMPOSITIONS FOR VEHICULAR SOUND DAMPING APPLICATIONS

(71) Applicant: Henkel AG & Co. KGaA, Duesseldorf (DE)

(72) Inventors: Fiona Cappel, Rauenberg (DE); Ralf Sauer, St. Leon-Rot (DE); Michael Klotz, Duesseldorf (DE); Hangzhen Wu, Mannheim (DE)

(21) Appl. No.: 18/211,411

(22) Filed: Jun. 19, 2023

Related U.S. Application Data
(63) Continuation of application No. PCT/EP2021/082597, filed on Nov. 23, 2021.

(30) Foreign Application Priority Data
Dec. 18, 2020 (EP) 20215283.1

(51) Int. Cl. C09D 7/61; C09D 133/08; C09D 5/16; C08J 7/04; C08J 7/18

(52) U.S. Cl. CPC C09D 7/61; C09D 133/08; C09D 5/16; C08J 7/0427; C08J 7/18; C08J 2333/08

(57) ABSTRACT

The present invention is directed to an aqueous coating composition comprising, based on the weight of the composition:
from 1 to 15 wt. % of a) at least one acrylic copolymer;
from 50 to 75 wt. % of b) particulate pigment, wherein said pigment particles have an aspect ratio of from 1 to 2 and comprise first and second uncoated calcium carbonate particle grades, said first uncoated calcium carbonate grade being characterized by an average particle diameter (d₅₀) of from 2 to 4 μm and a d₉₈ of from 20 to 30 μm and said second uncoated calcium carbonate grade being characterized by an average particle diameter (d₅₀) of from 20 to 40 μm and a d₉₈ of from 150 to 250 μm; and,
from 0.5 to 5 wt. % of c) at least one rosin ester.

### FIELD OF THE INVENTION

This invention relates to a liquid applied sound damping composition which has utility for motor vehicle applications. More particularly, the present invention is directed to an aqueous, liquid applied sound damping composition comprising calcium carbonate filler and dispersed acrylic copolymer.

### BACKGROUND TO THE INVENTION

Oscillating vehicle parts—such as the engine, tires or transmission system—give rise to bodywork vibrations that can lead to unpleasant noises within the passenger compartment. It is therefore long established that vibration damping systems be applied in a targeted manner to those areas of the vehicular bodywork that are affected.

Historically, one of the most common ways to reduce such vibration has been through the adherence of bituminous or asphaltic patches to metallic or plastic parts of the vehicular body. Whilst such patches tend to be effective in damping sound, they are labor intensive to install and must further be manufactured in a multiplicity of shapes and sizes so as to have utility at different points of the vehicular body frame and within different vehicle types.

Pumpable and sprayable compositions—known as liquid applied sound damping (LASD) compositions—provide an alternative to said bituminous patches. As compared to those patches, LASD compositions—which can be characterized as either aqueous or non-aqueous systems—have a higher damping efficiency and can thus be applied at a reduced basis weight. Further, spray installation allows for more focused application of the LASD sound damping material. Noting that laser-assisted vibrational analysis of motor vehicles can now identify areas of increased vibration within the vehicular body, those areas can be precisely targeted by computer-guided spray installation. With bituminous patches, it was more facile to make and install one large patch that covered several vibrational “hot spots” rather than making and installing several smaller patches.

As is known in the art, the polymeric fraction of non-aqueous LASD coating compositions is very often based on rubbers, epoxy resins, PVC plastisols, polyurethanes or acrylate powders. Certainly, non-aqueous LASD compositions present the advantage that, in the drying stages of their application, they usually solidify quickly and do not generate water vapor which can lead to unwanted cracking and blistering of the coating. Moreover, non-aqueous LASD coating compositions tend to exhibit good stability towards moisture and a high abrasion resistance. However, contraction of the coating composition after application may occur—particularly with epoxy resins—which can lead to a distortion in the metal vehicle panel. In addition, the application of such polymeric fractions must often be facilitated through the use of large quantities of plasticizer which provide no contribution to the damping effect and thus diminish the damping effect per unit mass. Still further, non-aqueous LASD compositions which are either solvent borne or urethane-based present obvious drawbacks environmentally with regards to VOC emissions and isocyanate migration respectively.

Aqueous LASD compositions based on acrylate dispersions are notable for good damping qualities and have also been described in the literature.

U.S. Pat. No. 8,163,380 (Hoefflin et al.) discloses an article of manufacture comprising: an automotive component to be subjected to external vibrational disturbances when inserted into a vehicle; and, a composition applied onto said component, the composition being capable of enduring paint bake heating operations, for dampening the vibrational disturbances. The applied composition comprises: a water-based resin; and, a polysaccharide drying control agent wherein the polysaccharide comprises from 0.1% to 20% by weight of the damping composition.

US20090121174A1 (Johnson et al.) describes a composition comprising: (a) a water borne polymeric binder, wherein said binder comprises from 0.05 to 20 wt. %, based on the total weight of polymer solids, of carboxy acid monomers, present as copolymerized monomers in pendant polyacid sidechain groups, wherein the binder has a calculated Tg of between −50 and 80° C.; (b) a filler, wherein on a dry weight basis the ratio of filler to polymer is from 1:1 to 10:1; and, (c) a thickener in an amount sufficient to achieve a shear thinnable composition that has a Brookfield viscosity of between 200,000 and 10,000,000 when not under shear conditions. The volume solids content of the composition is between 50 and 75%.

EP 1935941 A1 (Rohn and Hass) describes a composition comprising: (a) a water borne polymeric binder, wherein said binder comprises from 0.03% to 3 wt. % phosphorus present as copolymerized pendant phosphorus acid groups and wherein the binder has a calculated Tg of between −50° and 80° C.; (b) a filler, wherein on a dry weight basis the ratio of filler to polymer is from 1:1 to 10:1; and, (c) a thickener in an amount sufficient to achieve a shear thinnable composition that has a Brookfield viscosity of between 200,000-10,000,000 when not under shear conditions, wherein the volume solids content of the composition is between 50 and 75%.

EP 1520865 A2 (Nippon Catalytic Chemical Industries) describes a water-based emulsion for a vibration damper, said emulsion comprising: i) a particle comprising a core part formed of an acrylic copolymer (A) and a shell part formed of an acrylic copolymer (B) which covers the core part, the glass transition point of the acrylic copolymer (B) being not lower than −9° C., and the difference between the glass transition point of the acrylic copolymer (B) and the glass transition point of the acrylic copolymer (A) being not less than 20° C.

EP 2420412 A1 (BASF SE) describes a sound-absorbing paint comprising: a polymer dispersion obtained by emulsion polymerization of radically polymerizable monomers in a water-dispersed polymer having a glass transition temperature of −60 to 60° C.; inorganic fillers; and, at least one fluorinated compound selected from perfluoroalkyl-substituted carboxylic acids, fluorocarbon resins, fluoro-aliphatic polymeric esters and fluoro-containing copolymers based on acrylate.

US 2012027941 A1 (Fonseca et al.) describes a polymer dispersion for preparing sound deadener compositions, the polymer dispersion being obtainable by emulsion polymerization of free-radically polymerizable monomers in the presence of at least one protective colloid which is an amphiphilic graft copolymer having a polyalkylene oxide main chain and vinyl ester-comprising side chains.

The use of aqueous LASD compositions does mitigate the concerns with the presence of volatile organic compounds. However, problems with such coatings have been identified. Firstly, as water evaporates from the compositions when they dry upon a substrate, there may be cracking or blistering of the formed coating if a water vapor barrier forms within the composition: such effects, whilst they can be mitigated by curing the coatings under nitrogen gas, can still be sufficient to lift the coating from the substrate, diminishing the dimensional stability of the coating and reducing its ability to effect sound damping. Secondly, the coatings formed from aqueous compositions are both porous and contain hydrophilic auxiliaries such as emulsifiers: as a consequence of the capillary effect, the coatings can absorb water over time, particularly when located in regions of high humidity, which absorption diminishes the stability of the coating.

It will be recognized that aqueous LASD contain finely divided inorganic fillers, such as limestone, calcium carbonate, silicate minerals and aluminosilicate minerals. It has been prevalent in the art to use acicular or flake-like inorganic fillers—such as mica—as these increase the stiffness of the material and thereby enhance the damping loss factor of the material. However, whilst elevated levels of acicular or flake-like fillers—at or near the Critical Pigment Volume Concentration (cPVC)—might enhance the damping properties, at higher filler concentrations the material will possess surface defects, will become too stiff to handle, will lack conformability to shaped areas of the substrate and will become prone to cracking or breaking. As a consequence, the level of filler is reduced to a level which is well below the cPVC to enhance conformability at a concomitant loss of overall damping performance.

### STATEMENT OF THE INVENTION

In accordance with a first aspect of the invention, there is provided an aqueous coating composition comprising, based on the weight of the composition:
from 1 to 15 wt. % of a) at least one acrylic copolymer;
from 50 to 75 wt. % of b) particulate pigment, wherein said pigment particles have an aspect ratio of from 1 to 2 and comprise first and second uncoated calcium carbonate particle grades, said first uncoated calcium carbonate grade being characterized by an average particle diameter (d₅₀) of from 2 to 4 μm and a d₉₈ of from 20 to 30 μm and said second uncoated calcium carbonate grade being characterized by an average particle diameter (d₅₀) of from 20 to 40 μm and a d₉₈ of from 150 to 250 μm; and,
from 0.5 to 5 wt. % of c) at least one rosin ester.

Through the necessary presence of both particulate grades of calcium carbonate and of the rosin ester and acrylic copolymer auxiliaries, the pigment content of the coating composition may closely approach Critical Pigment Volume (cPVC) which leads to an advantageous sound damping performance.

In an embodiment, the aqueous coating composition comprises, based on the weight of the composition:
from 5 to 10 wt. %, preferably 5 to 7.5 wt. % of a) said at least one acrylic copolymer;
from 55 to 70 wt. %, preferably 60 to 70 wt. % of b) said particulate pigment, wherein said pigment particles have an aspect ratio of from 1 to 2 and comprise first and second uncoated calcium carbonate particle grades, said first uncoated calcium carbonate grade being characterized by an average particle diameter (d₅₀) of from 2 to 4 μm and a d₉₈ of from 20 to 30 μm and said second uncoated calcium carbonate grade being characterized by an average particle diameter (d₅₀) of from 20 to 40 μm and a d₉₈ of from 150 to 250 μm;
from 0.5 to 5 wt. %, preferably 1 to 3.5 wt. % of c) said at least one rosin ester; and,
from 5 to 15 wt. %, preferably from 5 to 10 wt. % of water.

The first uncoated calcium carbonate grade is preferably further characterized by a purity of at least 99.5%. The second uncoated calcium carbonate grade is preferably further characterized by a purity of from 97 to 99%.

Said first and second uncoated calcium carbonate grades are preferably included in the composition in a ratio by weight of first: second grades of from 1:2 to 2:1, for example from 1:1.5 to 1.5:1 or from 1:1.2 to 1.2:1. Moreover, uncoated calcium carbonate particles should in toto constitute the major component of the pigments present in the composition. More particularly, at least 75 wt. %, based on the total weight of pigment, preferably at least 80 wt. % or at least 90 wt. % of particulate pigment should be constituted by said uncoated calcium carbonate. In an embodiment, the particulate pigment either consists essentially of or consists of said first and second uncoated calcium carbonate particle grade.

Good results have been obtained where each rosin ester present in the composition is characterized by: a weight average molecular weight (Mw) below 10,000 daltons, preferably below 2,500 daltons; and/or a softening point of from 50° to 130° C., preferably from 60° to 120° C.

In accordance with a second aspect of the invention there is provided the use of the aqueous coating composition as defined herein above and in the appended claims as a liquid applied sound damping composition for a vehicle.

In accordance with a third aspect of the invention, there is provided a method of preparing a coated substrate, said method comprising:
applying the aqueous coating composition as defined herein above and in the appended claims to at least one surface of the substrate; and,
curing the coating composition.

The composition of the present invention can be applied without the need for a flow of nitrogen or air which gases would be, under prior art application processes, incorporated into the applied coating.

The present invention also provides for a vehicular panel obtained by the defined method. Even when formed without entrained nitrogen or air, a coating may be obtained without blistering during the curing process. The obtained coatings are robust: the coatings can be subjected to an applied vacuum—that is a pressure of less than 100 mbar—without deterioration of the integrity of the coating.

### DEFINITIONS

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps. If used, the phrase “consisting of” is closed, and excludes all additional elements. Further, the phrase “consisting essentially of” excludes additional material elements, but allows the inclusions of non-material elements that do not substantially change the nature of the invention.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The words “preferable”, “preferred”, “preferably”, “particularly” and “desirably” are used frequently herein to refer to embodiments of the disclosure that may afford particular benefits, under certain circumstances. However, the recitation of one or more preferable, preferred, particular or desirable embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

As used herein, room temperature is 23° C. plus or minus 2° C.

As used herein “curing” means a process of hardening of a material. The term is intended to encompass the drying of the material through the evaporation of water and co-solvents from the material and also, where applicable, the cross-linking of components within the material which possess reactive groups.

For purposes of this invention, weight average molecular weight (Mw) is determined by gel permeation chromatography against a polystyrene standard.

Viscosities of the composition compositions may be determined using the Brookfield Viscometer, Model RVT at standard conditions of 20° C. and 50% Relative Humidity (RH). The viscometer is calibrated using silicone oils of known viscosities, which vary from 5,000 cps to 50,000 cps. A set of RV spindles that attach to the viscometer are used for the calibration. Measurements of the passivation compositions are done using the No. 6 spindle at a speed of 20 revolutions per minute for 1 minute until the viscometer equilibrates. The viscosity corresponding to the equilibrium reading is then calculated using the calibration.

The term “softening point” as used herein refers to the temperature at which a material, such as a polymer, loses its solid characteristics and becomes relatively fluid. A material's softening point as given herein is that temperature measured using the standard ball and ring method according to ASTM E28.

As used herein, the glass transition temperature (Tg) is determined by differential scanning calorimetry (DSC) employing a 20 K/min ramp rate and midpoint measurement in accordance with DIN 53 765.

As used herein, by “d₅₀ particle size” is meant that the particle size distribution is such that at least 50% of the particles by weight have a particle size diameter of less than the specified value. As used herein, by “d₉₈” particle size is meant that the particle size distribution is such that at least 98% of the particles by weight have a particle size diameter of less than the specified value. Unless otherwise stated, that particle size is determined by laser diffraction.

The “critical pigment volume concentration” (cPVC) is herein defined as the point at which there is just sufficient binder to provide a completely absorbed layer on the pigment surface as well as all the interstitial spaces between the pigment particles in a close-packed system. It will be recognized that cPVC represents a point—as PVC increases—at which the physical properties of a coating change abruptly. The cPVC may be determined by oil absorption (OA) in accordance with ASTM D281-95(2007).

As used herein, the term “alloy” refers to a substance composed of two or more metals or of a metal and a non-metal which have been intimately united, usually by being fused together and dissolved in each other when molten. The term “zinc alloy” therefore denotes an alloy of which zinc metal is a constituent component, which zinc will generally comprise at least 40 wt. %—more typically at least 50 wt. % or at least 60 wt. %—of the alloy, on a metals basis. Metals which may be alloyed with zinc include, but are not limited to, aluminium, tin, nickel, titanium and cobalt. Herein, for a zinc/aluminum alloy, it is preferred that zinc constitutes, on a metals basis, at least 40 wt. % of the alloy and conversely that aluminum constitutes, on a metals basis, up to 60 wt. % of the alloy.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “polyfunctional”, as used herein, refers to the possession of more than one polymerizable moiety.

The term “ethylenically unsaturated monomer” as used herein, refers to any monomer containing a terminal double bond capable of polymerization under normal conditions of free-radical addition polymerization.

As used herein, “(meth)acryl” is a shorthand term referring to “acryl” and/or “methacryl”. Thus the term “(meth)acrylate” refers collectively to acrylate and methacrylate.

The term “hydrocarbyl group” is used herein in its ordinary sense, which is well-known to those skilled in the art.

As used herein, “C₁-Cₙ alkyl” group refers to a monovalent group that contains 1 to n carbons atoms, that is a radical of an alkane and includes straight-chain and branched organic groups. As such, a “C₁-C₃₀ alkyl” group refers to a monovalent group that contains from 1 to 30 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more halogen. Where applicable, a preference for a given substituent will be noted in the specification. In general, however, a preference for alkyl groups containing from 1-18 carbon atoms (C₁- C₁₈ alkyl)—for example alkyl groups containing from 1 to 12 carbon atoms (C₁-C₁₂ alkyl) or from 1 to 6 carbon atoms (C₁-C₆ alkyl)—should be noted.

The term “C₁-C₁₈ hydroxyalkyl” as used herein refers to a HO-(alkyl) group having from 1 to 18 carbon atoms, where the point of attachment of the substituent is through the oxygen-atom and the alkyl group is as defined above.

An “alkoxy group” refers to a monovalent group represented by -OA where A is an alkyl group: non-limiting examples thereof are a methoxy group, an ethoxy group and an iso-propyloxy group. The term “C₁-C₁₈ alkoxyalkyl” as used herein refers to an alkyl group having an alkoxy substituent as defined above and wherein the moiety (alkyl-O-alkyl) comprises in total from 1 to 18 carbon atoms: such groups include methoxymethyl (—CH₂OCH₃), 2-methoxyethyl (—CH₂CH₂OCH₃) and 2-ethoxyethyl.

The term “C₂-C₄ alkylene” as used herein, is defined as saturated, divalent hydrocarbon radical having from 2 to 4 carbon atoms.

The term “C₃-C₃₀ cycloalkyl” is understood to mean a saturated, mono-, bi-or tricyclic hydrocarbon group having from 3 to 30 carbon atoms. In the present invention, such cycloalkyl groups may be unsubstituted or may be substituted with one or more halogen. In general, a preference for cycloalkyl groups containing from 3-18 carbon atoms (C₃-C₁₈ cycloalkyl groups) should be noted. Examples of cycloalkyl groups include: cyclopropyl; cyclobutyl; cyclopentyl; cyclohexyl; cycloheptyl; cyclooctyl; adamantane; and, norbornane.

As used herein, an “C₆-C₁₈ aryl” group used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present invention, such aryl groups may be unsubstituted or may be substituted with one or more halogen. Exemplary aryl groups include: phenyl; (C₁-C₄) alkylphenyl, such as tolyl and ethylphenyl; indenyl; naphthalenyl, tetrahydronaphthyl, tetrahydroindenyl; tetrahydroanthracenyl; and, anthracenyl. And a preference for phenyl groups may be noted.

As used herein, “C₂-C₂₀ alkenyl” refers to hydrocarbyl groups having from 2 to 20 carbon atoms and at least one unit of ethylenic unsaturation. The alkenyl group can be straight chained, branched or cyclic and may optionally be substituted with one or more halogen. The term “alkenyl” also encompasses radicals having “cis” and “trans” configurations, or alternatively, “E” and “Z” configurations, as appreciated by those of ordinary skill in the art. In general, however, a preference for unsubstituted alkenyl groups containing from 2 to 10 (C₂₋₁₀) or 2 to 8 (C₂₋₈) carbon atoms should be noted. Examples of said C₂-C₁₂ alkenyl groups include, but are not limited to: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)═CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “alkylaryl” refers to alkyl-substituted aryl groups and “substituted alkylary” refers to alkylaryl groups further bearing one or more substituents such as halo, nitro, cyano, amido, amino, sulfonyl, sulfinyl, sulfanyl, sulfoxy, urea, thiourea, sulfamoyl, sulfamide and hydroxy. Further, as used herein “aralkyl” means an alkyl group substituted with an aryl radical as defined above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

The present compositions are defined herein as being “substantially free” of certain compounds, elements, ions or other like components. The term “substantially free” is intended to mean that the compound, element, ion or other like component is not deliberately added to the composition and is present, at most, in only trace amounts which will have no (adverse) affect on the desired properties of the coating. The term “substantially free” encompasses those embodiments where the specified compound, element, ion, or other like component is completely absent from the composition or is not present in any amount measurable by techniques generally used in the art.

### DETAILED DESCRIPTION OF THE INVENTION

### A: Acrylic Emulsion Copolymer

The present invention provides an aqueous emulsion of an acrylic base copolymer. It is preferred that the acrylic copolymers of the emulsion are characterized by at least one of: a glass transition temperature of from −30° C. to 60° C.; and, a weight average molecular weight of from 50000 to 500000 daltons.

There is no particular intention to limit the constituent monomers from which this copolymer is derived. However, it is preferred that, based on the total weight of monomers, at least 70 wt. % and preferably at least 80 wt. %, of the monomers from which the copolymer is derived are (meth) acrylate ester monomers. In particular, said (meth)acrylate ester monomers may be in accordance with the definitions a1) to a3) given herein below.

### a1) Aliphatic and Cycloaliphatic (Meth)acrylate Monomers

In an embodiment, the copolymer may comprise a1) at least one (meth)acrylate monomer represented by Formula I:

H₂C═CGCO₂R¹ (I)

wherein: G is hydrogen, halogen or a C₁—C₄ alkyl group; and,
R¹ is selected from:
C₁-C₃₀ alkyl; C₂-C₃₀ heteroalkyl; C₃-C₃₀ cycloalkyl; C₂-C₈ heterocycloalkyl;
C₂-C₂₀ alkenyl; and, C₂-C₁₂ alkynyl.

For example, R₁ may be selected from C₁-C₁₈ alkyl, C₂-C₁₈ heteroalkyl, C₃-C₁₈ cycloalkyl; C₂-C₈ heterocycloalkyl; C₂-C₈ alkenyl, and, C₂-C₈ alkynyl.

Desirably, said monomer(s) a1) are characterized in that R¹ is selected from C₁-C₁₈ alkyl and C₃-C₁₈ cycloalkyl. This statement of preference is expressly intended to include that embodiment wherein R¹ is C₁-C₆ hydroxylalkyl.

Examples of (meth)acrylate monomers a1) in accordance with Formula (I) include but are not limited to: methyl (meth)acrylate; ethyl (meth)acrylate; butyl (meth)acrylate; hexyl (meth)acrylate; 2-ethylhexyl (meth)acrylate; dodecyl (meth)acrylate; lauryl (meth)acrylate; cyclohexyl (meth)acrylate; isobornyl (meth)acrylate; 2-hydroxyethyl (meth)acrylate (HEMA); 2-hydroxypropyl (meth)acrylate; ethylene glycol monomethyl ether (meth)acrylate; ethylene glycol monoethyl ether (meth)acrylate; ethylene glycol monododecyl ether (meth)acrylate; diethylene glycol monomethyl ether (meth)crylate; trifluoroethyl (meth)acrylate; and, perfluorooctyl (meth)acrylate.

### a2) Aromatic (Meth)acrylate Monomers

In a further embodiment, which is not mutually exclusive of that given above, the copolymer may comprise a2) at least one (meth)acrylate monomer represented by Formula II:

H₂C═CQCO₂R² (II)

wherein: Q may be hydrogen, halogen or a C₁-C₄ alkyl group; and,
R² may be selected from C₆-C₁₈ aryl, C₁-C₉ heteroaryl, C₇—C₁₈ alkaryl and C₇-C₁₈ aralkyl.

Exemplary (meth)acrylate monomers a2) in accordance with Formula (II)—which may be used alone or in combination—include but are not limited to: benzyl (meth)acrylate; phenoxyethyl (meth)acrylate; phenoxydiethylene glycol (meth)acrylate; phenoxypropyl (meth)acrylate; and, phenoxydipropylene glycol (meth)acrylate.

### a3) (Meth)acrylate-functionalized Oligomer

In still further embodiment—which is again not intended to be mutually exclusive of the inclusion of aliphatic and cycloaliphatic monomers (a1) and aromatic monomers (a2)—the copolymer may comprise a3) at least one (meth)acrylate-functionalized oligomer. Said oligomers may have one or more acrylate and/or methacrylate groups attached to the oligomeric backbone, which (meth)acrylate functional groups may be in a terminal position on the oligomer and/or may be distributed along the oligomeric backbone.

It is preferred that said at least one (meth)acrylate functionalized oligomers: i) have two or more (meth)acrylate functional groups per molecule; and/or, ii) have a weight average molecular weight (Mw) of from 300 to 1000 daltons.

Examples of such oligomers, which may be used alone or in combination, include but are not limited to: (meth)acrylate-functionalized urethane oligomers such as (meth)acrylate-functionalized polyester urethanes and (meth)acrylate-functionalized polyether urethanes; (meth)acrylate-functionalized polyepoxide resins; (meth)acrylate-functionalized polybutadienes; (meth)acrylic polyol (meth)acrylates; polyester (meth)acrylate oligomers; polyamide (meth)acrylate oligomers; and, polyether (meth)acrylate oligomers. Such (meth)acrylate-functionalized oligomers and their methods of preparation are disclosed in inter alia: U.S. Pat. Nos. 4,574,138; 4,439,600; 4,380,613; 4,309,526; 4,295,909; 4,018,851; 3,676,398; 3,770,602; 4,072,529; 4,511,732; 3,700,643; 4,133,723; 4,188,455; 4,206,025; 5,002,976. Of the aforementioned polyether (meth)acrylates oligomers, specific examples include but are not limited to: PEG 200 DMA (n≈4); PEG 400 DMA (n≈9); PEG 600 DMA (n≈14); and, PEG 800 DMA (n≈19), in which the assigned number (e.g., 400) represents the weight average molecular weight of the glycol portion of the molecule.

The present invention does not preclude the copolymer a) being derived from ethylenically unsaturated non-ionic monomers not conforming to the definitions of a1), a2) and a3). Without intention to limit the present invention, such further ethylenically unsaturated non-ionic monomers may include: silicone (meth)acrylate monomers, such as those taught by and claimed in U.S. Pat. No. 5,605,999 (Chu); α,β-ethylenically unsaturated monocarboxylic acids containing 3 to 5 carbon atoms such as acrylic acid, methacrylic acid, crotonic acid; C₁-C₁₈ alkyl esters of crotonic acid; α,β-ethylenically unsaturated dicarboxylic acids containing from 4 to 6 carbon atoms and the anhydrides, monoesters, and diesters of those acids; vinyl esters such as vinyl acetate, vinyl propionate and monomers of the VEOVA™ series available from Shell Chemical Company; vinyl and vinylidene halides; vinyl ethers such as vinyl ethyl ether; vinyl ketones including alkyl vinyl ketones, cycloalkyl vinyl ketones, aryl vinyl ketones, arylalkyl vinyl ketones, and arylcycloalkyl vinyl ketones; aromatic or heterocyclic aliphatic vinyl compounds; poly(meth)acrylates of alkane polyols, such as ethylene glycol di(meth)acrylate, propylene glycol di(meth)acrylate, butylene glycol di(meth)acrylate, neopentyl glycol di(meth)acrylate, hexylene glycol di(meth)acrylate, trimethylolpropane tri(meth)acrylate, glycerin tri(meth)acrylate, and pentaerythritol tetra(meth)acrylate; poly(meth)acrylates of oxyalkane polyols such as diethylene glycol di(meth)acrylate, dipropylene glycol di(meth)acrylate, triethylene glycol di(meth)acrylate, tetraethylene glycol di(meth)acrylate, dibutylene glycol di(meth)acrylate, di(pentamethylene glycol)dimethacrylate; polyethylene glycol di(meth)acrylates; and, bisphenol-A di(meth)acrylates, such as ethoxylated bisphenol-A (meth)acrylate (“EBIPMA”).

Representative examples of other ethylenically unsaturated polymerizable non-ionic monomers include, without limitation: ethylene glycol dimethacrylate (EGDMA); fumaric, maleic, and itaconic anhydrides, monoesters and diesters with C₁-C₄ alcohols such as methanol, ethanol, propanol, isopropanol, butanol, isobutanol, and tert-butanol. Representative examples of vinyl monomers include, without limitation, such compounds as: vinyl acetate; vinyl propionate; vinyl ethers, such as vinyl ethyl ether; and, vinyl ethyl ketone. Representative examples of aromatic or heterocyclic aliphatic vinyl compounds include, without limitation, such compounds as styrene, α-methyl styrene, vinyl toluene, tert-butyl styrene, 2-vinyl pyrrolidone, 5-ethylidene-2-norbornene and 1-, 3-, and 4-vinylcyclohexene.

As is known in the art, the acrylic base copolymer may be prepared from the starting monomers by an aqueous emulsion polymerization process in the presence of a water-soluble free-radical initiator and under appropriate heating. The polymerization medium may comprise water and water-miscible liquids, such as C₁-C₄ alkanols, but preferably consists only of water. The polymerization temperature may be in the range from 30° C. to 120° C., for example from 50° C. to 100° C.: that temperature need not be held constant but may, for example, be raised during the emulsion polymerization.

Suitable free radical initiators, which are conventionally used in an amount between 0.05 and 5 wt. % based on the total weight of monomers used, include: hydrogen peroxide; alkyl hydroperoxides, such as t-butylhydroperoxide and cumene hydroperoxide; persulphates, such as NH₄-persulphate, K-persulphate and Na-persulphate; organic peroxides, such as acyl peroxides and including benzoyl peroxide; dialkyl peroxides, such as di-t-butyl peroxide; peroxy esters, such as t-butyl perbenzoate; and, azo-functional initiators, such as azo-bis(isobutyronitrile) (AIBN), 2,2′-azo-bis(2-methyl butane nitrile) (ANBN) and 4,4′-azobis(4-cyanovaleric acid).

The aforementioned peroxy initiator compounds may in some cases be advantageously used in combination with suitable reductors to form a redox system. As suitable reductors, there may be mentioned: sodium pyrosulphite; potassium pyrosulphite; sodium bisulphite; potassium bisulphate; acetone bisulfite; hydroxymethane sulfinic acid; and, isoascorbic acid. Metal compounds such as Fe.EDTA may also be usefully employed as part of the redox initiator system.

The person of skill in the art will be able to select an appropriate regimen for the addition of the initiator to the polymerization vessel in the course of the free radical aqueous emulsion polymerization. It can be introduced both completely into the polymerization vessel, or used continuously or in stages according to its consumption in the course of the free radical aqueous emulsion polymerization. Preferably, a part is initially charged and the remainder supplied according to the consumption of the polymerization.

The aqueous polymerization is typically performed in the presence of from 0.1 to 5.0 wt %, based on the total weight of monomers, of emulsifier. Preferably non-ionic emulsifiers are employed, optionally in combination with anionic emulsifiers. As suitable non-ionic emulsifiers there may be mentioned linear or branched polyoxyethylene alcohols having from 5 to 50 ethylene oxide (EO) units. As suitable anionic emulsifiers there may be mentioned C₁-C₁₈ alkane sulfates, C₁-C₁₈ alkane sulfonates and phosphate esters.

In the emulsion polymerization according to the invention, aqueous dispersions of the polymer are generally obtained with a solids content of greater than 60% by weight. Further, the acrylic emulsion copolymer should be obtained with a mono-modal particle size distribution characterized in that the average particle size (d50) of the polymer particles in the aqueous dispersion is from 50 to 400 nm, for example from 50 to 200 nm. The aqueous dispersions—as obtained—may be further processed or may be directly admixed with the further components to form the aqueous coating composition.

### B: Pigment Particles

The present composition comprises from 50 to 75 wt. %, for example from 55 to 70 wt. %, of particulate pigment, wherein said pigment particles have an aspect ratio of from 1 to 2 and comprise or consist of first and second uncoated calcium carbonate particle grades. The first uncoated calcium carbonate grade is characterized by an average particle diameter (d₅₀) of from 2 to 4 μm and a d₉₈ of from 20 to 30 μm. The first uncoated calcium carbonate grade is preferably further characterized by a purity of at least 99.5%. The second uncoated calcium carbonate grade is characterized by an average particle diameter (d₅₀) of from 20 to 40 μm and a d₉₈ of from 150 to 250 μm. The second uncoated calcium carbonate grade is preferably further characterized by a purity of from 97 to 99%.

Said first and second uncoated grades should be included in the composition in a ratio by weight of first grade:second grade of from 1:2 to 2:1, for example from 1:1.5 to 1.5:1 or from 1:1.2 to 1.2:1. It is noted that these ratio terms encompass a 1:1 ratio by weight of the first and second uncoated grades and this ratio does represent a preferred embodiment of the invention.

Uncoated calcium carbonate should in toto constitute the major component of the pigments present in the composition. More particularly at least 75 wt. %, based on the total weight of pigment, and preferably at least 80 wt. % or at least 90 wt. % of particulate pigment should be constituted by said uncoated calcium carbonate. The presence of other pigments is thereby not precluded and as examples of suitable further pigments there may be mentioned: coated calcium carbonate; limestone; fumed silica; glass spheres; iron oxides (Fe₂O₃, Fe₃O₄, FeOOH); lead oxides; strontium chromates; barium sulfate; titanium dioxide; and, carbon black. Any further pigmentary particles included in the composition should be spherical or nodular—diameter possessing an aspect ratio of from 1 to 2—and should have an average particle (d₅₀) of from 0.1 to 100 μm.

### C: Rosin Esters

As used herein, rosin ester refers to chemicals having the following generalized structure:

X—C(═O)—O—R

wherein: X is rosin or rosin derivative; and,
R represents any organic group.

The “rosin” portion of the rosin ester is, or is derived from, the standard material of commerce known as rosin. Rosin is mainly a mixture of C₂₀, tricyclic fused-ring, monocarboxylic acids: whilst pimaric acid and abietic acid are the predominant acids, any one or more of the C₂₀cyclic carboxylic acid-containing isomers present in rosin is suitable as the rosin portion of the rosin ester.

There is no particular intention to limit the source of the rosin which may utility in the present invention. Exemplary sources of rosin include but are not limited to: gum rosin resins; hydrogenated gum rosin resin; wood rosin resin; hydrogenated wood rosin; tall oil rosin resins; hydrogenated tall oil rosin resins; and, mixtures of two or more thereof. For completeness, dehydrogenation of rosin may be achieved by heating rosin at a temperature of from 100 to 300° C. in the presence of a dehydrogenation catalyst. Typical dehydrogenation catalysts in the art include palladium, rhodium and/or platinum, which metals may optionally be provided with a solid support such as silica, alumina and carbon.

The above aside, it is preferred herein that the or each rosin ester present in the composition is characterized by a weight average molecular weight (Mw) below 10,000 daltons, preferably below 2,500 daltons and more preferably below 2000 daltons. In a different expression of preference, which is not intended to be mutually exclusive of the molecular weight condition, it is preferred herein for the or each rosin ester present in the composition to have a softening point of from 50° to 130° C., preferably from 60° to 120° C. and more preferably from 70° to 110° C.

With regard to the substituent R in the above general formula, the rosin ester is preferably the reaction product of rosin with a hydroxyl-functional compound. Whilst that compound may be a phenol-formaldehyde condensate, it is herein preferred that the hydroxyl-functional compound is a non-phenolic hydroxyl-functional organic compound. Said compounds may be monohydric or polyhydric, the latter possessing for instance from 2 to 6 hydroxyl groups. It is further preferred that the reactant hydroxyl compound has only primary and/or secondary hydroxyl groups: tertiary hydroxyl groups are not preferred as they tend to be unstable under esterification conditions.

The reactant non-phenolic hydroxyl-containing compound is desirably selected from the group consisting of: C₁-C₂₂ monohydric compounds, in particular C₁-C₈ monohydric compounds; C₂-C₃₆ dihydric compounds, in particular C₂-C₈ dihydric compounds; C₃-C₃₆ trihydric compounds; C₅-C₃₆ tetrahydric compounds; C₅-C₃₆ pentahydric compounds; and, C₆-C₃₆ hexahydric compounds.

Exemplary C₁-C₂₂monohydric compounds include but are not limited to: methanol; ethanol; n-propanol; n-butanol; n-hexanol; 2-ethylhexanol; n-decanol; n-dodecanol; and, n-hexadecanol. Exemplary C₂-C₃₆ dihydric compounds include but are not limited to: ethylene glycol; propylene glycol; neopentyl glycol; diethylene glycol; triethylene glycol; 1,4-butanediol; 1,6-hexanediol; 1,8-octanediol; neopentylglycol; and, 1,4-cyclohexanedimethanol. Exemplary C₃-C₃₆ trihydric compounds include but are not limited to: glycerol; trimethylolpropane; and, trimethylolethane. Pentaerythritol and sugars may be mentioned as exemplary C₃-C₃₆ tetrahydric compounds. Dimerized trimethylolpropane and sugars are some of the C₅-C₃₆ pentahydric compounds that could be used in the present invention: analogously dimerized pentaerythritol (dipentaerythritol) is a viable C₆-C₃₆ hexahydric compound.

A particular preference for the use as component c) of glycerol and pentaerythritol esters of gum rosins, wood rosins and tall-oil rosins might be noted, of which esters commercial examples include: Foral 105 available from Eastman Chemical Company; Sylvalite RE100S, Sylvatac™ RE85 and Sylvatac™ RE95 available from Kraton Corporation.

### Adjunct Ingredients

The compositions of the present invention will typically further comprise adjunct materials, which are necessarily minor components but which can nevertheless impart improved properties to these compositions. The total amount of adjunct materials in the compositions will preferably be up to 10 wt. %, and more preferably from 0.1 to 10 wt. % or from 0.1 to 7.5 wt. % based on the total weight of the composition. The desired viscosity of the compositions will typically be determinative of the total amount of adjunct materials added.

Included among such adjunct materials are: plasticizers; stabilizers; co-solvents; thickeners; drying control agents; dispersing agents, such as sodium hexametaphosphate, sodium tripolyphosphates or polycarboxylic acids; defoamers; and, blowing agents.

A “plasticizer” for the purposes of this invention is a substance that decreases the viscosity of the composition and thus facilitates its processability. Herein the plasticizer may constitute up to 5 wt. % or up to 2.5 wt. %, based on the total weight of the composition, and is preferably selected from the group consisting of: polydimethylsiloxanes (PDMS); diurethanes; ethers of monofunctional, linear or branched C4-C16 alcohols, such as Cetiol OE (obtainable from Cognis Deutschland GmbH, Düsseldorf); esters of butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; epoxidized plasticizers; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not preferred due to their toxicological potential. It is preferred that the plasticizer comprises or consists of one or more polydimethylsiloxane (PDMS).

“Stabilizers” for purposes of this invention are to be understood as antioxidants, UV stabilizers or hydrolysis stabilizers. Herein stabilizers may constitute in toto up to 5 wt. % or up to 2.5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulfur; and, mixtures thereof.

Examples of suitable co-solvents having utility in the present invention include: methanol; ethanol; propanol; isopropanol; n-butanol; isobutanol; tert-butanol; ethylene glycol; ethylene glycol alkyl ethers, such as Cellosolve® products; diethylene glycol alkyl ethers such as Carbitol® products; carbitol acetate; butylcarbitol acetate; or, mixtures thereof. However, it is preferred that that the composition is substantially free of organic solvents.

The drying control agent minimizes the occurrence of cracks and swelling in the damping coating films when the coating films are baked and dried. The use of a polysaccharide drying control agent based on cellulose or starch may be desirable with the use of water insoluble starch particularly preferred. In certain conditions, it may be beneficial to include water insoluble starch in the compositions in an amount up to 3 wt. %, based on the weight of the composition.

A variety of thickeners can be used, singly, or in combination, to produce the composition of this invention, Exemplary thickeners include but are not limited to: alkali-swellable emulsions (ASE); hydrophobically modified alkali-swellable emulsions (HASE); polyvinyl alcohols; cellulose derivatives such as hydroxyethyl cellulose; polyacrylic acids; ethoxylated urethanes; inverse emulsions; hydrophobically modified inverse emulsions; and, suspension polymers. Exemplary ASE polymers include ACULYN™ 33 and ACULYN™ 38, available from The Dow Chemical Company. Exemplary commercial HASE polymers include ACULYN™ 22, ACULYN™ 28, ACULYN™ 88 and ACULYN™ EXCEL, available from The Dow Chemical Company. Further exemplary HASE polymers are disclosed in U.S. Pat. Nos. 3,657,175; 4,384,096; 4,464,524; 4,801,671; 5,292,843, 5,874,495; 7,649,047; and 7,288,616 .

Examples of defoaming agents, which may be included alone or in combination, include: Surfynol™ materials available from Air Products; mineral oil; glycol ethers; acetlyene diol based defoamers; and, silicone defoamers. Suitable commercial examples of defoamers include those available from BYK Chemie under the designations: BYK®-052; BYK®-057; BYK®-066 N; BYK®-088; BYK®-354; BYK®-392; BYK®-031; BYK®-032; BYK®-033; BYK®-034; BYK®-035; BYK®-036; BYK®-037; BYK®-038; BYK®-017; BYK®-018; BYK®-019; BYK®-020; BYK®-021; BYK®-022; BYK®-023; BYK®-024; BYK®-025; BYK®-028 A; BYK®-044; BYK®-045; BYK®-060 N; BYK®-065; BYK®-066 N; BYK®-067 A; BYK®-070; BYK®-071; BYK®-080 A; BYK®-088; BYK®-094; BYK®-141; BYK®-1610; BYK®-1615; BYK®-1650; BYK®-1660; Byketol®-WS; BYK®-011; BYK®-012; BYK®-051; BYK®-052; BYK®-053; BYK®-055; BYK®-057; BYK®-A 500; BYK®-A 501; and, BYK®-A 530. Mention may also be made of the TECO® Foamex series of defoamers available from Tego Chemie Service GmbH.

### Exemplary Coating Composition

In two illustrative embodiments, which are not intended to be limiting of the present disclosure, there are provided coating compositions in accordance with Table 1 herein below:

TABLE 1

| | Illustrative | Illustrative |
|---|---|---|
| | Embodiment of the | Embodiment of the |
| | Present Invention | Present Invention |
| | (Wt. %, based on | (Wt. %, based on |
| | weight of | weight of |
| Ingredient | composition) | composition) |
| Acrylic Copolymer | 5-10 | 5-7.5 |
| Blend of first and | 55-70 | 60-70 |
| second uncoated | 1 | |
| calcium carbonate | | |
| particles | | |
| Rosin Ester | 0.5-5 | 1-3.5 |
| Graphite | 0 | 0 |
| Water | 5-10 | 5-10 |
| Dispersing Agent | 0-1 | 0-1 |
| Surfactant | 0-1 | 0-1 |
| Polysaccharide | 2-3 | 2-3 |
| Thickener | 0.5-1 | 0.5-1 |
| Blowing agent | 0-0.5 | 0-0.5 |
| Defoamer | 0-0.5 | 0-0.5 |
| Drying additive | 0-2 | 0-2 |

### METHODS AND APPLICATIONS

The aqueous compositions are formulated by simple mixing of the various components. Whilst the order of mixing of the components is not intended to be limited, it may be prudent to first form an aqueous dispersion of the acrylic copolymer and a separate aqueous dispersion of the rosin ester component before mixing said dispersions and the further components. In this scenario, the aqueous dispersion of the rosin ester may, for example, be prepared at a solids content of from 45 to 60 wt. %.

If necessary, the compositions may be prepared well in advance of its application. However, in an interesting alternative embodiment, a concentrated composition may first be obtained by mixing components with only a fraction of the water that would be present in the composition as applied: the concentrated composition may then be diluted with the remaining water shortly before its application. It is considered that such concentrated compositions may be prepared and stored as either single-package concentrates—that can be converted by dilution with water only—or as multi-part concentrates, two or more of which must be combined and diluted to form a complete working composition according to the invention. Any dilution can be effected simply by the addition of water, in particular deionized and/or demineralized water, under mixing. The composition might equally be prepared within a rinse stream whereby one or more streams of the concentrate(s) is injected into a continuous stream of water.

Without specific intention to limit the amount of water included in the aqueous compositions, it is preferred that said compositions contain from 5 to 15 wt. %, preferably from 5 to 10 wt. %, based on the weight of the composition, of water. In an alternative but not mutually exclusive characterization, the composition may be defined by a viscosity of from 1 to 10 Pa.s, for example 5 to 10 Pa.s, as measured using a Brookfield viscometer at 25° C.

In accordance with the broadest process aspects of the present invention, the above described compositions are applied to a substrate and then cured in situ. Prior to applying the compositions, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

In some embodiments, the adhesion of the coating compositions of the present invention to the preferably pre-treated substrate may be facilitated by the application of a primer thereto. Indeed, primer compositions may be necessary for to ensure the fixture and/or efficacious cure times of the compositions on inactive substrates such as plastics, stainless steel, zinc, zinc alloys and cadmium. Whilst the skilled artisan will be able to select an appropriate primer, instructive references for the choice of primer include but are not limited to: U.S. Pat. Nos. 3,855,040; 4,731,146; 4,990,281; 5,811,473; GB 2502554; and U.S. Pat. No. 6,852,193.

The compositions are then applied to the preferably pre-treated, optionally primed surfaces of the substrate by conventional application methods such as: brushing; roll coating; doctor-blade application; printing methods; and, spraying methods, including but not limited to air-atomized spray, air-assisted spray, airless spray and high-volume low-pressure spray.

The thickness of the applied coating in the present invention may be adjusted such that the final cured coating is effective in suppressing noise and vibration transmission to the desired extent. In many instances, the compositions will be applied to a wet film thickness of from 1 to 5 mm. The application of thinner layers within this range is more economical and provides for a reduced likelihood of deleterious thick cured regions. However, great control must be exercised in applying thinner coatings or layers so as to avoid the formation of discontinuous cured films.

The curing of the compositions of the invention typically occurs at temperatures in the range of from 80° C. to 150° C., preferably from 90° C. to 140° C. The temperature that is suitable depends on the specific compounds present and the desired curing rate and can be determined in the individual case by the skilled artisan, using simple preliminary tests if necessary. Where applicable, however, the temperature of the applied composition may be raised above the mixing temperature and/or the application temperature using conventional means including microwave induction.

The coating method of the present invention may further comprise reducing the oxygen content in the environment of the curing material: this may be done by introducing nitrogen (N₂) gas into the curing environment. This step is however not necessary for the formation of a robust coating.

For completeness, the present invention also concerns a method of preparing a multilayer, coated substrate. The method comprises, as one of the constituent steps, the application of the aqueous coating composition as defined hereinabove to the substrate as a basecoat. This step is followed by the application to said basecoat of a clear coating: the clear coating composition may be applied to the base coating on a wet-on-wet basis or may be applied after the intermediate curing of the basecoat. The multicoated substrate is then cured. There is not particular limitation on the type of clear coating which may be applied in this manner: both water and solvent borne coating compositions are envisaged.

There is no particular intention to the limit the substrates to which the present compositions may be applied. In application to vehicular panels, exemplary substrates may be metallic, polymeric or combinations thereof. However, particular mention may be made of: ferrous metals, such as iron, steel, and alloys thereof; non-ferrous metals, such as aluminum, zinc and alloys thereof; and, combinations thereof. In illustrative embodiments, the substrate may be formed from: cold rolled steel; electro-galvanized steel, such as hot dip electro-galvanized steel or electro-galvanized iron-zinc steel; or aluminum.

What is claimed is:

1. An aqueous coating composition comprising, based on the weight of the composition:
from 1 to 15 wt. % of a) at least one acrylic copolymer;
from 50 to 75 wt. % of b) particulate pigment, wherein said pigment particles have an aspect ratio of from 1 to 2 and comprise first and second uncoated calcium carbonate particle grades, said first uncoated calcium carbonate grade being characterized by an average particle diameter (d₅₀) of from 2 to 4 μm and a d₉₈ of from 20 to 30 μm and said second uncoated calcium carbonate grade being characterized by an average particle diameter (d₅₀) of from 20 to 40 μm and a d₉₈ of from 150 to 250 μm; and
from 0.5 to 5 wt. % of c) at least one rosin ester.

2. The aqueous coating composition according to claim 1, said composition comprising, based on the weight of the composition:
from 5 to 10 wt. % of a) said at least one acrylic copolymer;
from 55 to 70 wt. % of b) said particulate pigment, wherein said pigment particles have an aspect ratio of from 1 to 2 and comprise first and second uncoated calcium carbonate particle grades, said first uncoated calcium carbonate grade being characterized by an average particle diameter (d₅₀) of from 2 to 4 μm and a d₉₈ of from 20 to 30 μm and said second uncoated calcium carbonate grade being characterized by an average particle diameter (d₅₀) of from 20 to 40 μm and a d₉₈ of from 150 to 250 μm;
from 0.5 to 5 wt. % of c) said at least one rosin ester; and
from 5 to 15 wt. % of water.

3. The aqueous coating composition according to claim 1, wherein each acrylic copolymer is characterized by at least one of: a glass transition temperature of from −30° C. to 60° C.; and, a weight average molecular weight (Mw) of from 50000 to 500000 daltons.

4. The aqueous coating composition according to claim 1, wherein said acrylic copolymer is obtained by aqueous emulsion polymerization.

5. The aqueous coating composition according to claim 1, wherein the acrylic copolymer is dispersed within said composition with a mono-modal particle size distribution characterized in that the average particle size (d50) of the polymer particles in the aqueous dispersion is from 50 to 400 nm.

6. The aqueous coating composition according to claim 5, wherein the average particle size (d50) of the polymer particles in the aqueous dispersion is from 50 to 200 nm.

7. The aqueous coating composition according to claim 1, wherein the first uncoated calcium carbonate grade is further characterized by a purity of at least 99.5%.

8. The aqueous coating composition according to claim 1, wherein the second uncoated calcium carbonate grade is further characterized by a purity of from 97 to 99%.

9. The aqueous coating composition according to claim 1, wherein said first and second uncoated calcium carbonate grades are included in the composition in a ratio by weight of first grade:second grade of from 1:2 to 2:1.

10. The aqueous coating composition according to claim 1, wherein at least 75 wt. %, based on the total weight of pigment of said particulate pigment b) is constituted by said uncoated calcium carbonate.

11. The aqueous coating composition according to claim 1 to, wherein each rosin ester present in the composition is characterized by:
a weight average molecular weight (Mw) below 10,000 daltons; and/or
a softening point of from 50° to 130° C.

12. The aqueous coating composition according to claim 1 further comprising water insoluble starch in an amount up to 3 wt. %, based on the weight of the composition.

13. The aqueous coating composition as defined in claim 1 is used as a liquid applied sound damping composition for a vehicle.

14. A method of preparing a coated substrate, said method comprising:
applying the aqueous coating composition as defined in claim 1 to at least one surface of the substrate; and
curing the coating composition.

15. A vehicular panel obtained by the method as defined in claim 14.
